(19) United States
(12) Patent Application Publication
(10) Pub. No.: US 2023/0350008 A1
(43) Pub. Date: Nov. 2, 2023

(54) RADAR SENSOR WITH TRANSMISSION OF A LOCAL OSCILLATOR SIGNAL WITHIN A WAVEGUIDE STRUCTURE

(71) Applicant: Robert Bosch GmbH, Stuttgart (DE)

(72) Inventors: Frank Meinl, Leonberg (DE); Torge Bror Keuter, Pforzheim (DE)

(21) Appl. No.: 18/190,627

(22) Filed: Mar. 27, 2023

(30) Foreign Application Priority Data
May 2, 2022 (DE) 10 2022 204 287.5

(51) Int. Cl. G01S 7/03

(52) U.S. Cl. CPC G01S 7/032

(57) ABSTRACT

A radar sensor. The radar sensor includes an antenna device which at least emits a radar signal, an integrated high frequency component which generates the radar signal, a waveguide structure which transmits the radar signal between the antenna device and the integrated high frequency component and includes at least one waveguide, a signal transmission path for transmitting a local oscillator signal, on which the generated radar signal is based, within the radar sensor. At least portions of the signal transmission path are disposed within the waveguide structure.

### CROSS REFERENCE

The present application claims the benefit under 35 U.S.C. § 119 of German Patent Application No. DE 10 2022 204 287.5 filed on May 2, 2022, which is expressly incorporated herein by reference in its entirety.

### FIELD

The present invention relates to a radar sensor.

### BACKGROUND INFORMATION

German Patent Application No. DE 10 2020 209 307 A1 describes a radar sensor comprising a circuit board which is equipped with a high frequency component, in particular an MMIC, and a hollow conductor structure via which a radar signal is transmitted between the high frequency component and a hollow conductor antenna.

An object of the present invention is to improve distribution of a local oscillator signal within the radar sensor. An object of the present invention is to transmit the local oscillator signal within the radar sensor in a more cost-effective, space-saving and efficient manner.

### SUMMARY

At least one of the foregoing objects may be achieved with a radar sensor according to the present invention. The local oscillator signal can thus be transmitted more efficiently within the radar sensor. The radar sensor can be embodied in a more compact and cost-effective manner. The signal transmission path for transmitting the local oscillator signal within the radar sensor can be implemented in a more flexible manner.

The radar sensor can be disposed in a vehicle. The environment can be the surroundings of a vehicle. The radar sensor can enable an acquisition of the surroundings of the vehicle. The radar sensor can be embodied as a MIMO radar sensor.

The radar sensor can be associated with an assistance system, a semi-autonomous or autonomous driving system.

The integrated high frequency component can process the radar signal, in particular microwave frequencies, preferably in the gigahertz range. The integrated high frequency component can be embodied as an MMIC (monolithic microwave integrated circuit). The processing of the radar signal can include generating and/or receiving the radar signal.

A waveguide structure is understood to be a spatial structure comprising the waveguide for the bundled transmission of electromagnetic waves. The waveguide in the waveguide structure can preferably extend in all three spatial directions perpendicular to one another. The waveguide structure can form a compact assembly or single compact component.

The waveguide structure can be made of plastic, preferably an electrically non-conductive plastic. The plastic used can be an elastomer, Duroplast, and/or thermoplastic. The waveguide structure can be made of metal or a metal alloy, preferably aluminum, copper, brass or a combination of multiple materials.

The waveguide structure can have a multilayered structure. The waveguide structure can comprise at least two waveguides disposed one above the other. The waveguide structure can be constructed as a prefabricated block structure. The waveguide structure can comprise the antenna device. The antenna device and waveguide structure can be integrated.

The integrated high frequency component can be connected to the signal transmission path for receiving the local oscillator signal.

According to an example embodiment of the present invention, the antenna device can comprise an antenna region which is open to the environment and connected to the waveguide. The antenna device can also receive the radar signal. The radar sensor can comprise a further antenna device for receiving the radar signal. The waveguide structure can comprise a waveguide which transmits the radar signal between the antenna device that receives the radar signal and an integrated high frequency component which processes said radar signal.

In a preferred example embodiment of the present invention, it is advantageous if the radar sensor comprises at least two integrated high frequency components which are connected to the signal transmission path and which both process the common local oscillator signal.

According to an example embodiment of the present invention, the signal transmission path can comprise at least one branch, in particular a power splitter, for transmitting the local oscillator signal to the at least two integrated high frequency components.

An advantageous preferred embodiment of the present invention is one in which the radar sensor comprises a local oscillator which generates the local oscillator signal. The radar sensor can thus be constructed in a highly integrated manner. The local oscillator signal used in the radar sensor can be exclusively from a local oscillator.

In one advantageous embodiment of the present invention, it is provided that the radar sensor comprises a central integrated high frequency component as a local oscillator for generating a coherent distribution of the local oscillator signal to the at least two integrated high frequency components. A signal transmission path can respectively be formed between the integrated high frequency component and the central integrated high frequency component.

In a preferred embodiment of the present invention, it is provided that the waveguide structure is embodied as a hollow conductor structure and the waveguide is embodied as the hollow conductor channel which transmits the radar signal. The hollow conductor channel can be coated on the inside, preferably with a metal, for transmitting electromagnetic waves. The hollow conductor channel can comprise at least one cavity. The cavity can be filled with air. The hollow conductor channel can have any cross-section, preferably a rectangular cross-section.

The waveguide can be embodied as a solid-state line, which is in particular rigidly disposed in a solid body. For this purpose, conductive means, for example metals, can be combined with dielectric means, for example air or insulating materials, in a solid body.

In a preferred embodiment of the present invention, it is advantageous if the signal transmission path comprises a further waveguide disposed within the waveguide structure. This allows the local oscillator signal to be transmitted via the further waveguide within the waveguide structure. The waveguide structure can have a compact and highly integrated design. The signal transmission path can be functionally and/or spatially separate from the waveguide which transmits the radar signal.

The local oscillator signal can be transmitted along the signal transmission path mainly via the further waveguide. The largest proportion of the length of the signal transmission path can be occupied by the further waveguide or a plurality of such waveguides.

Aside from the dimensions, the further waveguide of the signal transmission path can be structured like the waveguide of the waveguide structure.

In a preferred embodiment of the present invention, it is advantageous if at least portions of the further waveguide are embodied as a hollow conductor channel, as a stripline and/or as a laminated waveguide. The hollow conductor channel can be coated on the inside, preferably with a metal, for transmitting electromagnetic waves. The hollow conductor channel can comprise at least one cavity. The cavity can be filled with air. The hollow conductor channel can have any cross-section, preferably a rectangular cross-section. The stripline can be a microstrip line.

An advantageous preferred embodiment of the present invention is one in which the signal transmission path comprises at least one amplifier, signal splitter and/or power splitter. The local oscillator signal can thus arrive at the required processing points, for example at two integrated high frequency components, as a common and identical signal. The amplifier can amplify the local oscillator signal.

In one advantageous embodiment of the present invention, it is provided that the radar sensor will have a carrier plate that receives the integrated high frequency component and the waveguide structure. The carrier plate can be embodied as a circuit board, in particular as a printed circuit board. The carrier plate can accommodate further components, for example electronic components, preferably on a side opposite to the waveguide structure. The waveguide structure can be accommodated directly on the carrier plate.

The signal transmission path can comprise a connection of the waveguide to the carrier plate. The signal transmission path can comprise a connection of the waveguide to the integrated high frequency component.

In a special example embodiment of the present invention, it is advantageous if the radar sensor comprises at least one connector connected to the signal transmission path for guiding the local oscillator signal out of the radar sensor. The connector can be embodied as a plug connection for connection to a counterpart of the to-be-connected component. The to-be-connected component can be a mechanically flexible waveguide in the form of a cable, in particular a coaxial cable.

The local oscillator signal can also be generated outside of the radar sensor and fed into the radar sensor via the connector to be distributed within the radar sensor via the signal transmission path.

Further advantages and advantageous embodiments of the present invention will emerge from the description of the FIGURE and the FIGURE.

### BRIEF DESCRIPTION OF THE DRAWING

FIG. 1 shows a cross-section of a radar sensor according to an example embodiment of the present invention.

### DETAILED DESCRIPTION OF EXAMPLE EMBODIMENTS

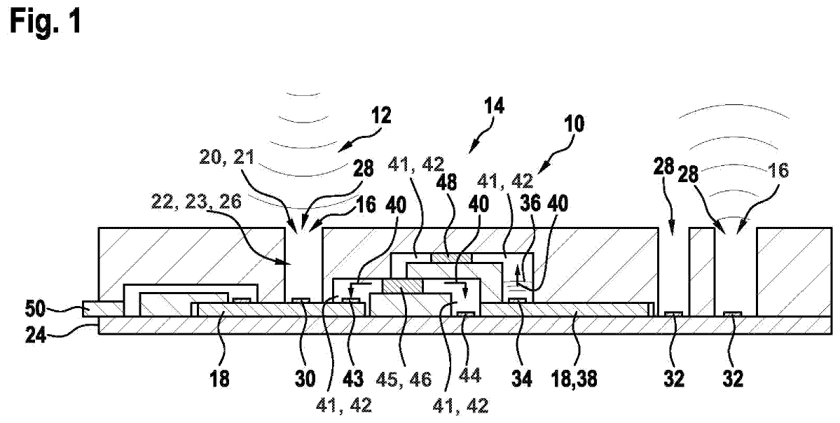

FIG. 1 shows a cross-section of a radar sensor in a special embodiment of the present invention. The radar sensor 10 is preferably disposed in a vehicle as part of an assistance system or a semi-autonomous or autonomous driving system. The radar sensor 10 can emit and preferably also receive a radar signal 12. The radar signal 12 can be emitted by the radar sensor 10 to an environment 14 of the vehicle by means of an antenna device 16, reflected from there and received by the radar sensor 10 by means of the antenna device 16.

The radar sensor 10 comprises a plurality of integrated high frequency components 18 which generate or process the radar signal 12 and also a waveguide structure 22, in particular a hollow conductor structure 23, which transmits the radar signal 12 between the antenna device 16 and the integrated high frequency components 18 and comprises a plurality of waveguides 20, in particular hollow conductor channels 21. The waveguide structure 22 is accommodated on a carrier plate 24 which is embodied as a circuit board. The carrier plate 24 is equipped with the multiple integrated high frequency components 18. The waveguide structure 22 is in particular embodied as an antenna hollow conductor structure 26 with an integrated antenna device 16.

An antenna device 16 comprises antenna regions 28 which are open to the environment 14 for emitting and/or receiving the radar signal 12. The integrated high frequency components 18 are respectively connected to the antenna regions 28 via connections 30, in particular in the form of LiP (launcher-in-package), LoP, AfiP (antenna feed in package). Alternatively, the antenna device 16 is connected to the carrier plate 24 via connections 32. The radar signal 12 is transmitted between the antenna regions 28 and the integrated high frequency components 18 via the connections 30, 32.

The radar sensor 10 further comprises a local oscillator 34 for generating a local oscillator signal 36 on which the generated radar signal 12 is based. The local oscillator signal 36 can be in a microwave frequency range. One of the integrated high frequency components 18 is preferably embodied as a central integrated high frequency component 38 which comprises the local oscillator 34, or is embodied as the local oscillator 34, and enables generation for coherent distribution of the local oscillator signal 36 to the integrated high frequency components 18.

The local oscillator signal 36 can be transmitted between the local oscillator 34 and the integrated high frequency components 18 via a plurality of signal transmission paths 40. The signal transmission paths 40 comprise a plurality of further waveguides 41, preferably a plurality of hollow conductor channels 42, for transmitting the local oscillator signal 36. The local oscillator signal 36 can thus be transmitted more efficiently within the radar sensor 10.

The hollow conductor channels 42 are disposed within the waveguide structure 22. At least one hollow conductor channel 42 is connected to the integrated high frequency component 18 via connections 43, in particular in the form of LiP (launcher-in-package), LoP, AfiP (antenna feed in package). Alternatively, at least one hollow conductor channel 42 is connected to the integrated high frequency component 18 via connections 44 and a stripline, in particular a microstrip line on the carrier plate 24.

The waveguide structure 22 further comprises a signal splitter or power splitter 46 for branching the local oscillator signal 36 into a plurality of signal transmission paths 40 which lead to respective integrated high frequency components 18. An amplifier 48, which amplifies the local oscillator signal 36 as needed, can be disposed within one of the signal transmission paths 40 as well.

The radar sensor 10 comprises a connector 50, which is connected to the signal transmission path 40 for guiding the local oscillator signal 36 in and/or out with respect to the radar sensor 10.

What is claimed is:

1. A radar sensor, comprising:
an antenna device which at least emits a radar signal;
an integrated high frequency component configured to generate the radar signal;
a waveguide structure configured to transmit the radar signal between the antenna device and the integrated high frequency component, and including at least one waveguide; and
a signal transmission path configured to transmit a local oscillator signal, on which the generated radar signal is based, within the radar sensor, at least portions of the signal transmission path being disposed within the waveguide structure.

2. The radar sensor according to claim 1, wherein the radar sensor includes at least two integrated high frequency components which are connected to the signal transmission path and which both configured to process a common local oscillator signal.

3. The radar sensor according to claim 1, wherein the radar sensor includes a local oscillator which generates the local oscillator signal.

4. The radar sensor according to claim 2, wherein the radar sensor includes a central integrated high frequency component as a local oscillator configured to generate a coherent distribution of the local oscillator signal to the at least two integrated high frequency components.

5. The radar sensor according to claim 1, wherein the waveguide structure is embodied as a hollow conductor structure and the waveguide is embodied as a hollow conductor channel configured to transmit the radar signal.

6. The radar sensor according to claim 1, wherein the signal transmission path includes a further waveguide disposed within the waveguide structure.

7. The radar sensor according to claim 6, wherein at least portions of the further waveguide are embodied as a hollow conductor channel and/or as a stripline and/or as a laminated waveguide.

8. The radar sensor according to claim 1, wherein the signal transmission path includes at least one amplifier and/or signal splitter and/or power splitter.

9. The radar sensor according to claim 1, wherein the radar sensor includes a carrier plate which accommodates the integrated high frequency component and the waveguide structure.

10. The radar sensor according to claim 1, further comprising at least one connector connected to the signal transmission path for guiding the local oscillator signal out of the radar sensor.
